(19) United States
(12) Patent Application Publication
(10) Pub. No.: US 2003/0183712 A1
(43) Pub. Date: Oct. 2, 2003

(54) Refining segment and refining apparatus comprising a refining disc with such refining segment

(76) Inventor: Nils Virving, Hasselby (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/297,517

(22) PCT Filed: Jun. 7, 2001
(86) PCT No.: PCT/SE01/01283

(30) Foreign Application Priority Data
Jun. 8, 2000 (SE) 0002155-0

(51) Int. Cl. B02C 1/10

(52) U.S. Cl. 241/296

(57) ABSTRACT

The present invention relates to a refining segment (8; 18) for a refining disc (4) included in refining apparatus for disintegrating and refining material containing lignocellulose in a refining gap (6) between two opposing refining discs (4, 5) rotatable in relation to each other, surrounded by a refiner housing (3). The invention is characterized in that the refining segment is provided along its entire periphery with a guide member (12; 22) for deflecting the refined material when it leaves the refining gap, so that it is not thrown straight against the wall of the refiner housing. The invention also relates to refining apparatus provided with such refining segments.

The present invention relates to a refining segment constituting at least part of a refining disc included in refining apparatus for disintegrating and refining material containing lignocellulose in a refining gap between two opposing refining discs rotatable in relation to each other, surrounded by a refiner housing. The invention also relates to a refining apparatus comprising a refining disc that includes one or more such refining segments.

Refining apparatus or disc refiners of this type are used, for instance, for highly concentrated refining, CTMP, TMP, fluffing and highly concentrated grinding of sack paper and other fibrous material containing lignocellulose. They usually comprise a rotatable refining disc, mounted on a rotor, and a non-rotatable refining disc, mounted on a stator. Refining discs in this type of refining apparatus are built up of refining segments that form refining surfaces. The refining segments are replaced at regular intervals due to considerable wear. They are either mounted directly on the rotor and stator, respectively, or by means of special segment holders. A refining disc may consist of one or more annular refining segments or of several divided, radial refining segments. Refining segments may be in the form of central segments and peripheral segments, the peripheral segments being located outermost along the periphery, and the central segments being located inside the peripheral segments. Between the refining disc/surfaces on the rotor and stator, respectively, is a space in the form of a refining gap.

A serious problem with this type of refining apparatus is that the refined material is thrown out in the form of pulp from the refining zone, i.e. the refining gap between the refining discs, straight into the wall of the surrounding refiner housing, thus causing considerable strain on the wall, as well as substantial wear. This applies particularly when impurities in the form of clay and sand are present in the pulp, as is the case with primarily board and return fibre pulp. According to conventional technology, therefore, a special wear part is sometimes installed, suitably situated, inside the refiner housing, which is replaced at regular intervals. This naturally entails some extra expense but otherwise the housing itself would be worn out, which obviously should be avoided. The object of the present invention is primarily to remedy this problem.

Another problem is that the pulp thrown out not only causes wear on the wall of the refiner housing but may also become lodged on it and build up to a cake of pulp. This occurs primarily between the rotatable parts and the refiner housing. This cake of pulp sometimes tends to become lodged and completely block transport of fibres to the outlet. Besides this obvious drawback, the build-up of pulp in the refiner housing also results in high friction along the periphery of the rotatable parts, and also considerable generation of heat which may cause the fibres to carbonise, becoming so hard that the rotor is turned as by a lathe, and may cause breakdown. Even if things do not reach this stage, the build-up of pulp causes continuous wear on the outer part of the rotor and the segment holder of the refining disc when used, so that they may break down in the end. Equivalent problems may also arise in refining apparatus of “double disc” type, i.e. having two refining discs rotatable against each other.

According to conventional technology attempts to eliminate these problems entail providing the rotor itself with wings that protrude into the space between the rotor and the wall of the refiner housing to keep it clean. However, these wings often give rise to cavitation damage in the attachment between wing and rotor, which may lead to the wing gradually becoming dislodged, with disastrous consequences.

The object of the present invention is to remedy the problems mentioned above by making use of a refining segment provided along its entire periphery with a guide member for deflecting the refined material when it leaves the refining gap, so that it is not thrown directly against the wall of the refiner housing. Thanks to the invention, thus, the advantage is gained of avoiding a good deal of the wear on the wall of the refiner housing immediately outside the refining gap by the pulp being guided forwards instead, along the periphery of the opposing refining disc and, insofar as it encounters the wall of the refiner housing, being spread over a larger area and encountering the wall with less force. The wear where the pulp encounters the wall of the refiner housing will thus be less and the tendency to build up a pulp cake is greatly reduced. Admittedly, the wear on the actual guide member is rather great but this poses no real problem since, in accordance with the proposed solution, they are joined to the refining segments and replaced simultaneously therewith. This is performed as a matter of routine, usually about once a month.

The guide member is designed to produce a deflection angle of up to 90° C. in relation to the substantially parallel refining surfaces formed by the two refining discs, preferably 45° C.-60° C.

In accordance with a preferred embodiment the guide member is in the form of a guiding lip along the periphery of the refining segment and protrudes outside the refining gap and substantially in the direction towards the opposing refining disc. The guide member is preferably made in one piece with the refining segment, which is usually cast. However, it is of course feasible for it to be a separate part which, for instance, is screwed onto the refining segment.

The refining segment in accordance with the invention may be a divided, radial refining segment situated along the periphery of the refining disc and provided with a guide member along its entire periphery, or it may be an annular refining segment provided with a guide member along its entire periphery.

The present invention also relates to a refining apparatus provided with a refining disc with such refining segments.

The invention will now be described with reference to the accompanying drawings, illustrating embodiments of the invention by way of example, in which

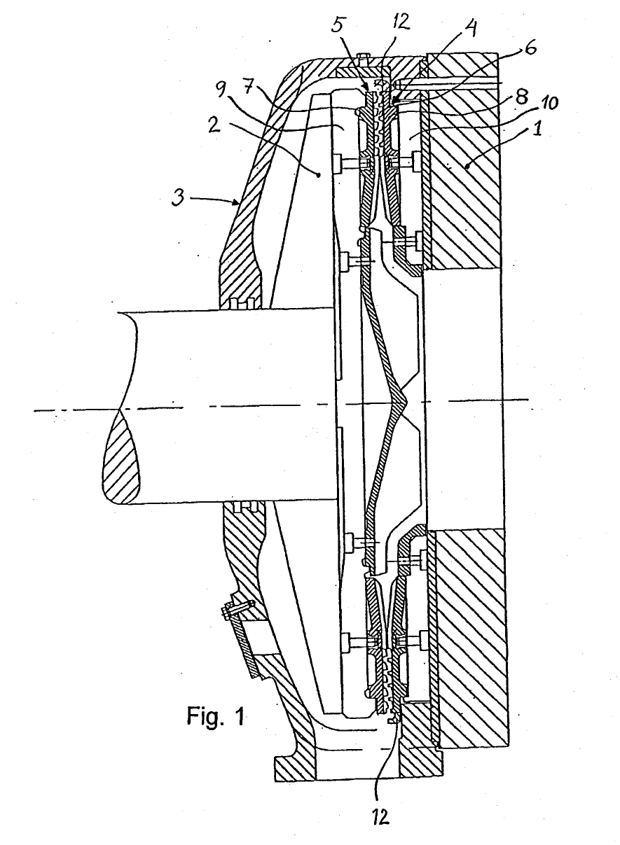

FIG. 1 shows a side view, in cross section, of a disc refiner in accordance with the present invention,

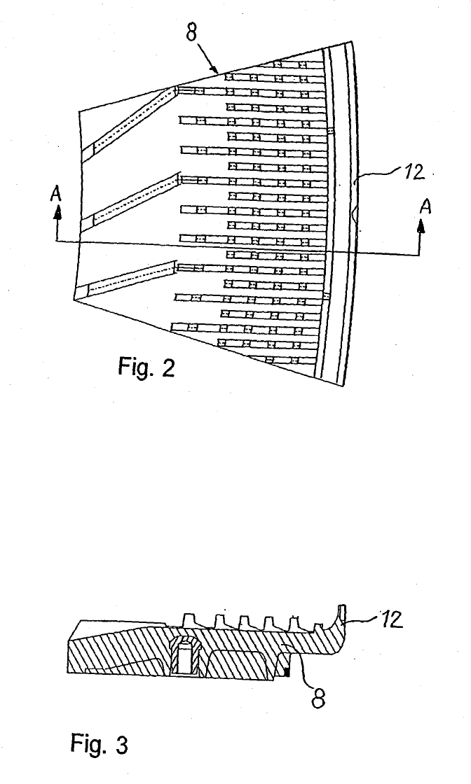

FIG. 2 shows an enlarged view from above of an embodiment of a refining segment in accordance with the present invention,

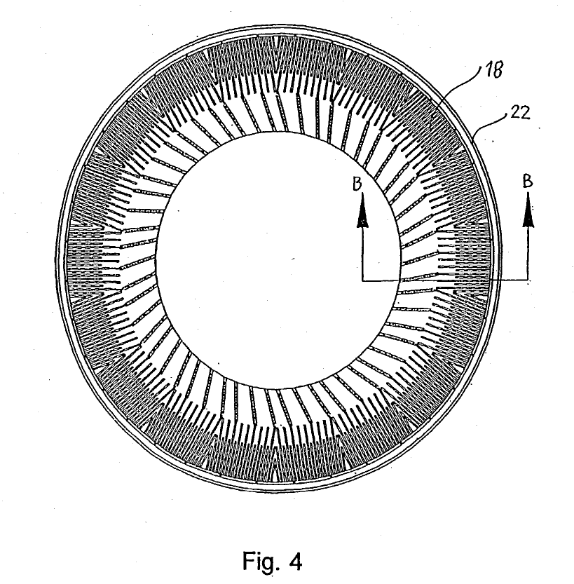

FIG. 3 shows an enlarged view in cross section of the refining segment in FIG. 2, taken along the line A-A, or alternatively the refining segment in FIG. 4 below, taken along the line B-B, and

FIG. 4 shows a view from above of a variant of a refining segment in accordance with the present invention, on a reduced scale.

FIG. 1 illustrates a disc refiner comprising a stationary part, stator 1, and a rotatable part, rotor 2, surrounded by a refiner housing 3. Refining discs 4, 5 are mounted on stator and rotor, respectively. These refining discs are generally divided into segments, known as refining segments or stator segments 8 and rotor segments 7, respectively, forming refining surfaces. The refining segments are normally pre-fitted on segment holders 9, 10, respectively, in order to enable quick exchanging. The number of segments may vary, as mentioned above. A stator refining disc generally has eight, twelve or eighteen segments and a rotor refining disc usually has the same number of segments. Alternatively, whole, i.e. undivided, refining discs are also possible in the case of small refineries.

A refining gap 6 is produced between the refining surfaces, where the material fed in is refined.

A refining segment 8 for a stator refining disc in accordance with one embodiment of the present invention is illustrated in detail in FIGS. 2 and 3. A “divided” refining segment or radial refining segment is seen here, intended to be placed along the periphery of the refining disc and which, together with a number of additional segments, forms the refining disc. The refining segment is provided along its entire periphery with a guiding lip 12 or overhang in the direction towards the opposing refining disc, in this case the rotor. The guiding lip protrudes outside the refining gap, see also FIG. 1, so that the refined material ejected from the refining gap is caught by the guiding lip and deflected inside the refiner housing with the aid thereof, in a direction substantially axially along the periphery of the rotor 2. Since it is advisable for all the outer, refining segments situated along the periphery of the stator refining disc 4 to be designed in the manner shown with a guiding lip along their entire periphery, a guiding lip similar to an unbroken ring or flange will be formed along the entire periphery of the stator disc. The guiding lip 12 is designed so that it forms an angle in relation to the refining surface formed by the refining disc, that produces a deflection of up to 90° C. in relation to the refining surface, but preferably between 45° C. and 60° C.

FIG. 4 illustrates a variant of a refining segment. This refining segment 18 is an annular refining segment provided with a guiding lip 22 along its entire periphery. The guiding lip is designed as shown in FIGS. 1 and 3 and a cross section of the refining segment 18 will be the same as shown in FIG. 3.

For both variants the guiding lip is preferably made in one piece with the refining segment, and of the same material, preferably with a rounded transition between the segment itself and the guiding lip. However, the guiding lip could also consist of a separate part secured to the periphery of the refining segment in suitable manner.

It should be particularly noted that the refining segment in accordance with the invention need not necessarily be mounted on a non-rotatable stator refining disc, but may instead be mounted on a rotatable refining disc, e.g. in refining apparatus of double-disc type.

The present invention shall not be deemed limited to the embodiments described here by way of example, but can be varied and modified in many ways, as will be realised by one skilled in the relevant technical area, within the scope of what is defined in the appended claims.

1. A refining segment (8; 18) intended to constitute at least a part of a refining disc (4) included in refining apparatus for disintegrating and refining material containing lignocellulose in a refining gap (6) between two opposing refining discs (4, 5) rotatable in relation to each other, surrounded by a refiner housing (3), characterized in that it is provided along its entire periphery with a guide member (12; 22) for deflecting the refined material when it leaves the refining gap, so that it is not thrown straight against the wall of the refiner housing.

2. A refining segment as claimed in claim 1, characterized in that the guide member (12; 22) is designed to produce a deflection angle of up to 90° in relation to the substantially parallel refining surfaces formed by the refining discs (4, 5).

3. A refining segment as claimed in claim 2, characterized in that said deflection angle is between 45° and 60°.

4. A refining segment as claimed in any one of the preceding claims, characterized in that the guide member (12; 22) is in the form of a guiding lip along the periphery of the refining segment (8; 18) and protrudes outside the refining gap (6) and substantially in the direction towards the opposing refining disc (5).

5. A refining segment as claimed in any one of the preceding claims, characterized in that the guide member (12; 22) is made in one piece with the refining segment (8; 18).

6. A refining segment as claimed in any one of claims 1-5, characterized in that the refining segment is a divided, radial refining segment (8) situated along the periphery of the refining disc and provided with a guide member (12) along its entire periphery.

7. A refining segment as claimed in any one of claims 1-5, characterized in that the refining segment is an annular refining segment (18) provided with a guide member (22) along its entire periphery.

8. A refining segment as claimed in any one of claims 1-7, characterized in that it is arranged on a non-rotatable refining disc.

9. Refining apparatus for disintegrating and refining material containing lignocellulose in a refining gap (6) between two opposing refining discs (4, 5) rotatable in relation to each other, surrounded by a refiner housing (3), characterized in that one refining disc (4) comprises at least one refining segment (8; 18) as claimed in any one of claims 1-7.

10. Refining apparatus as claimed in claim 9, characterized in that all the refining segments (8; 18) situated along the periphery of said refining disc (4) are designed as claimed in any one of claims 1-7.

11. Refining apparatus as claimed in claim 9 or claim 10, characterized in that said refining disc (4) is a non-rotatable refining disc.
